(19) United States
(12) Patent Application Publication
(10) Pub. No.: US 2005/0185600 A1
(43) Pub. Date: Aug. 25, 2005

(54) Meeting aid

(75) Inventor: Christopher John Nicholls, London (GB)

Correspondence Address: PEARNE & GORDON LLP, 1801 EAST 9TH STREET, SUITE 1200, CLEVELAND, OH, 44114-3108, US

(73) Assignee: Synanto Ltd., London, ENG (GB)

(21) Appl. No.: 10/516,269

(22) PCT Filed: May 23, 2003
(86) PCT No.: PCT/GB03/02234

(30) Foreign Application Priority Data
May 28, 2002 (GB) 0212297.6

(51) Int. Cl. H04Q 11/00

(52) U.S. Cl. 370/260; 370/352

(57) ABSTRACT

A meeting aid (10) configured to facilitate the identification of persons in attendance at a meeting, said meeting aid being one of a set of such meeting aids each for allocation to a said person in attendance at a meeting, the meeting aid comprising:
a data input device (60) configured to allow the person to whom the meeting aid has been allocated to input information identifying themselves;
communication means (65) for receiving identifying information from one or more of the other meeting aids of said set of meeting aids;
a processor (70) configured to process and save received identifying information and identifying information inputted by the person to whom the meeting aid has been allocated, said saved identifying information providing the person to whom the meeting aid has been allocated with a list comprising at least a portion of the identifying information associated with those persons to whom each meeting aid of the set of meeting aids has been allocated; and
display means (50) responsive to said processing means to display at least a portion of the inputted and received identifying information.

### FIELD OF THE INVENTION

This invention relates to meeting aids. Preferred embodiments relate to a system for facilitating the identification of persons in attendance at a meeting.

### BACKGROUND TO THE INVENTION

It has long been recognised, in business for example, that face-to-face meetings are a valuable communication method. Whether it is between members of different businesses, firms, or organisations, or in interdepartmental meetings in large corporations, meeting other people to discuss ideas is probably one of the fastest ways for promulgating a new idea, or business practise.

However, when attending a meeting it is not uncommon for many of the attendees, if not all of the attendees, to not know some or any of the other attendees.

A number of different approaches have previously been suggested to tackle this problem. For example, it has been proposed to take a roll-call at the start of the meeting to introduce each participant to the other attendees.

However, this approach is not particularly useful as it is often difficult for the attendees to remember the names of the other participants, let alone additional information such as contact details or for which firm a person works. Writing the details down of each attendee is time consuming, and as a result often results in the meeting being delayed. It also introduces the possibility of errors being made, which can have embarrassing consequences for subsequent relationships.

Another previously proposed approach is for each attendee to write their name on a nametag or the like. However, one cannot guarantee that everyone can read each other's writing, and the writing of nametags wastes time—to say nothing of the fact that the tags cannot be reused once they have been written upon.

Yet another approach is for the host of the meeting to write each attendees' name on a cardboard tag and place the relevant tag at the relevant position reserved for that person at the meeting table. Putting aside the fact that it is easy to misspell the names of the attendees, the most significant problem with this approach is that it requires the host of the meeting to have prior knowledge of the identity of the attendees. Unfortunately this approach is not entirely satisfactory, as the host often does not know exactly who will be attending. Furthermore, if a given participant cannot attend and a replacement is sent in their stead, then that replacement will not have a tag and a new one must be made up on their arrival—causing delay and inconvenience to the host and other attendees.

An aim of the present invention is to alleviate one or more of these problems, and particularly to seek an advancement or alternative to existing arrangements.

### STATEMENT OF INVENTION

In pursuit of this aim, a first aspect of the present invention provides a meeting aid having the features set forth in claim 1.

This aspect of the invention provides an aid that allows inputted identity information concerning participants of the meeting to be displayed so that the identification of a given participant by other participants can readily be improved. The aid is eminently re-usable, and thus avoids the waste associated with the aforementioned cardboard tags, as well as the expense incurred in purchasing blank tags.

Preferably the inputted identifying information relates to an attendee's name and, potentially, additional details such as the company for which they work, and/or their contact details.

In a preferred embodiment the meeting aid includes a plurality of display means, typically numbering two, three or four (or more). Each display means preferably shows the same information. Preferably the plurality of display means are arranged equally around a circumference of the device. In a highly preferred embodiment a meeting aid of the present invention is substantially cuboidal or elongate-prism shaped (i.e. a three dimensional device with a triangular footprint). A display screen is preferably disposed in two or more of the sidewalls of the device. This arrangement gives the advantage that the display screens are visible from a plurality of locations. Thus, if a series of meeting aids are arranged on a table, with a particular meeting aid assigned to a particular person then each person in the meeting should clearly be able to see at least one of the displays on the meeting aid assigned to any other given person.

Other preferred features of this aspect of the invention are set out in claims 2 to 27. Second and third aspects of the invention provide a system as claimed in claim 23 or 26.

### BRIEF DESCRIPTION OF THE DRAWINGS

The above and further features of the present invention are set forth with particularity in the appended claims and together with advantages thereof will become clearer from consideration of the following detailed description of illustrative embodiments of the present invention with reference to the accompanying drawings, in which:

FIG. 1 illustrates a meeting aid system comprised of a plurality of meeting aids arranged on a meeting table;

FIG. 2 illustrates another meeting aid system comprised of a plurality of meeting aids arranged on a meeting table that are configured to communicate with one another;

FIG. 3 illustrates another meeting aid system comprised of a plurality of meeting aids in association with a base unit arranged on a meeting table;

FIG. 4 illustrates another meeting aid system comprised of a plurality of meeting aids arranged on a meeting table, and in association with a remote base unit;

FIG. 5 illustrates another meeting aid system comprised of a plurality of meeting aid systems arranged on a plurality of meeting tables, all of the meeting aid systems being associated with a single base unit;

FIG. 6 shows a perspective view of a meeting aid;

FIG. 7 shows a perspective view of a base unit;

FIG. 8 illustrates core functional units of the aid of FIG. 6;

FIG. 9 illustrates core functional units of the base unit of FIG. 7;

FIG. 10 illustrates another meeting aid in accordance with an embodiment of the invention.

### DETAILED DESCRIPTION OF PREFERRED EMBODIMENTS

As will now be described, a meeting aid embodying the principles of the invention can be operated in any of a number of different modes in dependence upon factors such as the number of aids in a given meeting aid system, the number of persons in attendance at a given meeting, and the number of meeting aid systems in a given organisation.

The following illustrative examples will focus primarily on situations where persons attending a meeting identify themselves by means of their names, but it will be appreciated that the participants may choose any label (such as their job title for example) to identify themselves.

This may prove particularly useful in circumstances where two or more people are assigned to only one meeting aid. In such circumstances, all of those people could input their contact details into the meeting aid that has been assigned to them, and then the aid could simply display a collective name (such as “Company Lawyers”, for example) for all of those participants.

FIG. 1 is a schematic illustration of the simplest envisaged incarnation of a first meeting aid system. In this arrangement, the system comprises a plurality of meeting aids 10 (referred to hereinafter as “satellite units” for ease of reference) that have been arranged around a table 20. Each participant of a meeting is assigned a particular satellite unit 10 for use during the meeting, and the satellite units may be numbered to help participants to locate their assigned satellite unit 10.

Before the meeting commences each participant inputs data, such as their name (and optionally other information such as their company name or contact details), into their satellite unit 10. In this embodiment, the satellite units are configured to display that inputted data (and optionally any other information inputted by the participants) on a display means of the satellite unit. Typically, the display means will comprise a plurality of display screens, and as will later be described in detail, the screens may be configured so that any participant of the meeting should be able to see the displayed data inputted by other participants of the meeting. This allows the participants to easily identify one another, and to make a note of the identity (at least) of the participants as the meeting progresses. It is apparent therefore that this arrangement provides an elegantly simple means for avoiding the problems set out above.

In the preferred arrangement, meeting participants will be able to choose which aspect of the inputted information they wish to have displayed to the other participants. They may also be able to choose to change the information displayed to other participants.

As will be explained in detail below, in an envisaged implementation the satellite units will be configured simply to display the name of a participant. In an alternative implementation, the satellite units could be configured to display the name of a participant, and in addition further items of inputted information such as the name of the company that that participant works for, or their contact details. The name of the participant and the additional information could be scrolled through the display, or alternatively the units could be configured to display each item of inputted information cyclically one after the other with an appropriate time delay to permit other participants to make a note of the displayed information.

FIG. 2 illustrates a more sophisticated meeting aid system than that shown in FIG. 1. In this arrangement, the satellite units 10 are configured to communicate with one another. Suitable devices are provided in each of the satellite units 10 to implement this communication function. In a preferred arrangement the communication devices are operable to implement wireless communications—one-way and/or two-way—between the satellite units 10, and as such could comprise an infrared transceiver, a cellular transceiver or indeed a radio transceiver. As a further less preferable option, the units could of course be wired to one another. The communication devices may be configured to allow information to be sent from one unit to all other units simultaneously, or to just a selection of the units. Alternatively, the units could be configured so that one unit is designated a master unit capable of collating information received from other units, those other units only being capable of transmitting information to the master unit.

This system is advantageous in that it allows messages and the like to be sent, at least, from one unit to other satellite units 10. It would also be possible, for example, for inputted information to be transmitted to and collated at the other satellite units. In this case, each participant would then have a list of all the participants at their disposal. If the satellite units were configured so that one of the aforementioned display screens faces a participant, then that participant could display, and optionally scroll through, the list on the facing screen preferably without affecting the information (such as their name for example) displayed on the other display screens. The participant would then be able to make a note of the other participants, or alternatively they could download the list—by means of the communications devices or some other means—onto a suitable medium such as a mobile telephone, a laptop computer or a portable digital assistant.

In an alternative highly preferred embodiment, the device has a triangular footprint and comprises a pair of rectangular display screens on the two, generally upright, faces of the triangular body that will face the other meeting participants in use. A third display screen may be provided in the other face of the body, or more preferably the third display screen may be inset into the top face of the triangular body. The third display screen is intended primarily for use by the meeting participant to whom the meeting aid has been assigned, and as such the information displayed on that third screen may be the same as or different to the information displayed to the other meeting participants via the other two screens. Typically, the third screen will display operating instructions or menus, for example, whereas the other two screens will display the identifying information that that user wishes to be displayed to the other participants.

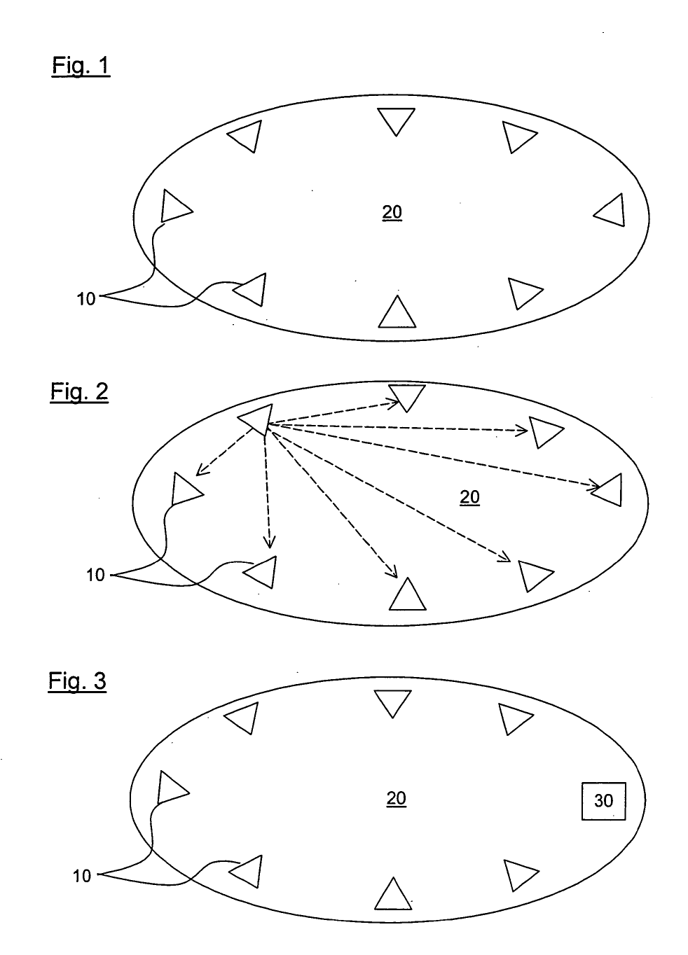

FIG. 3 illustrates a further meeting aid system that is yet more sophisticated than that shown in FIG. 2.

In this arrangement, a plurality of satellite units 10 are associated with a more sophisticated unit that will hereafter be referred to as “a base unit” 30. As will be described in detail later, the base unit preferably comprises all the functionality of the satellite units, and additional more sophisticated features. In this arrangement, each of the satellite units 10 are capable of interacting with the base unit 30 so that information entered into each of the satellite units 10 can be transmitted by suitable means to the base unit 30. This allows all the information entered into the satellite units 10 by the participants to be correlated in the base unit, and hence provides for a record of the attendees at the meeting and their company and contact details. The base unit 30 comprises a printer so that hard copies of the correlated information can be produced for dispersal to the participants—thereby obviating the need for them to make their own record. As a further additional or alternative feature, the base unit may comprise means to provide an electronic copy of the correlated information (such as, for example, means to enable the information to be saved onto a memory card—e.g. a USB memory card).

In a proposed implementation, the chairperson or secretary of the meeting—for example—is assigned to the base unit 30, and the other participants are assigned to satellite units. The chairperson is then able to generate a list of the participants, together with their contact details, and dispense the list to the participants so that everyone has a record of who was present at the meeting.

In a highly preferred arrangement, each of the satellite units are configured to preface transmissions to the base unit with a code that uniquely identifies each satellite unit in the system. The base station is provided with a list of the codes identifying each satellite unit, and an indication of the position around the table of each satellite unit with respect to the base unit. With this information, the base unit is then able to correlate information from the satellite units to generate a list providing not only the inputted information for each participant, but also an indication of where the participants were sat for the meeting. This allows the generated list to serve as a useful aide memoire, particularly for large meetings, that makes it easier for participants to put “names to faces” in the future.

A particular advantage of this arrangement is that it allows the purchaser to keep costs down without compromising on functionality of the system as a whole. This is because the purchaser need only acquire one base unit 30, and a plurality of less expensive satellite units in order to provide a working system.

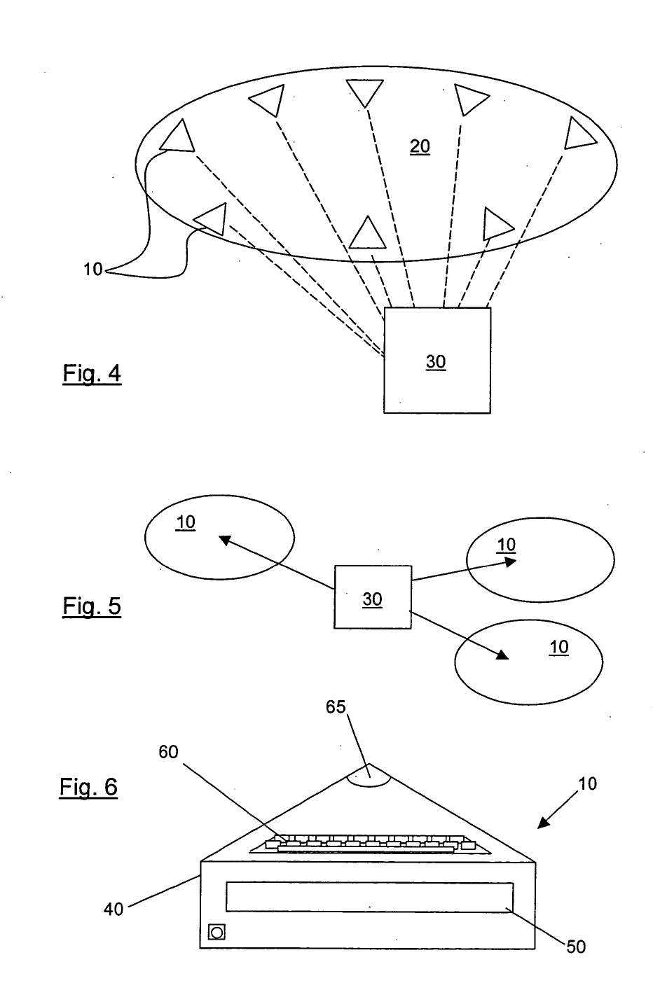

FIG. 4 illustrates a modification of the meeting aid system of FIG. 3. In this arrangement the base unit 30 is located remotely from the meeting table 20.

In a further modification, depicted in FIG. 5, a single base unit 30 may service a plurality of meeting aid systems that each comprise a plurality of satellite units 10. For example, an organisation with a building containing a plurality of meeting rooms could install satellite units 10 in each room, and install a base unit 30 remote from these rooms for communication with each set of satellite units 10. In this arrangement the base unit may be different to the base unit described with reference to FIG. 3, and could simply comprise an appropriately programmed computer that is capable of communicating—preferably wirelessly—with each set of satellite units.

In a further embodiment, each of the satellite units may be wired to, or wirelessly linked with, a printer.

In its simplest incarnation, as shown in FIG. 6, a satellite unit 10 embodying the invention comprises a casing 40 with display means—in this arrangement a plurality of liquid crystal or light-emitting-diode display screens 50—arranged around its periphery (n.b. only one display screen is visible in FIG. 1).

In the preferred arrangement, the satellite units are shaped to have a triangular footprint as it has been found that this provides the greatest field of view for the display screens. It will be appreciated, however, that the satellite units need not be triangular. They could instead have a square footprint, or indeed a circular footprint. All that is required is that the unit should be shaped so that the display means mounted in the peripheral walls of a given unit assigned to one participant can readily be seen by the other participants of the meeting.

The satellite unit 10 also comprises input means (in this example a keyboard 60 with a standard “QWERTY” key layout) to enable participants of a meeting to enter data into the unit. As an alternative to a keyboard, the satellite units could instead comprise a navigation device (such as a number of cursor keys, or a mouse or trackball) and a selection device (such as a key or button) that a participant can use as a means to scroll through a list of characters and select a desired character in order to build up words and/or numbers. A numerical keypad may be used as a further alternative input means.

As mentioned above, data input by a participant will typically be—as a minimum—their name. The input data may additionally comprise, for example, details of the company that a given participant works for and/or their contact details. Any information can be inputted into the units, and thus the scope of the invention should not be construed as being limited to any of the examples set out above, and elsewhere in this document.

As a highly preferred option, each unit may additionally comprise a calculator (not shown). In the preferred arrangement, the calculator is recessed into the underside of the casing 40 so that the unit can still sit flush on top of a table. To use the calculator a participant need simply invert the unit.

In the particular example shown in FIG. 6, the satellite unit also comprises an infrared input/output interface 65 so that, as a minimum, data can be: (i) transmitted from the unit, and optionally also received by the unit or (ii) received by the unit, and optionally also transmitted from the unit.

As an alternative to an infrared input and/or output interface, the unit could comprise any other sort of wireless interface (such as a cellular or radio transmitter and/or receiver), or indeed an appropriate connection point (such as an RJ11 socket or RS232 socket, for example) to permit the units to be wired to one another. Communication between units could alternatively be provided by means of a wireless LAN, a Bluetooth™ chip or indeed any other communications device known to persons skilled in the art.

In the above-described systems, power for each of the satellite units and the base unit may be provided by an internal rechargeable battery or alternatively by a mains source. However, other sources, such as solar power, may be used.

FIG. 8 is a schematic illustration of the core components of the satellite unit 10 shown in FIG. 6. As mentioned above, data can be inputted by a user to the unit 10 by means of a keyboard or other input device 60. The unit comprises a processor 70 connected to the input means 60 and display means 50 by way of a data bus, and the processor is operable to process input data for subsequent display by the display means 50. A memory 80 is provided to enable the processor to store input data. As shown in ghost in FIG. 8, a communications interface (preferably a wireless communications interface) is provided so that the unit can communicate with other units.

Preferably, the unit is constructed in a modular fashion so that components can easily be replaced in the event of a malfunction. An advantage of such a construction is that a user could initially purchase a simplified unit without a communications function (i.e. the unit as shown in FIG. 6 minus those components shown in ghost), and then subsequently purchase and install an appropriate communications module.

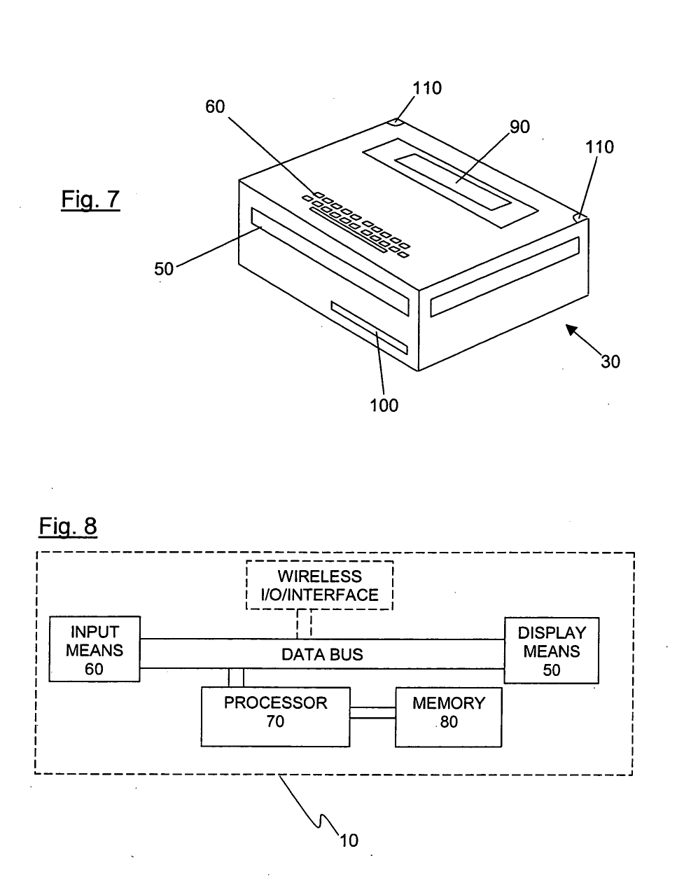

FIG. 7 is a schematic representation of a base unit 30, such as those mentioned above with reference to FIG. 3, FIG. 4 and FIG. 5. In common with the aforementioned satellite unit 10, the base unit 30 comprises input means 60, display means 50, a processor 70, and a memory 80 all interconnected by means of a data bus. These features are attributed like reference numerals as in the embodiment supra, and, for brevity, will not be described further.

As shown in FIG. 7 the base unit 30 further comprises a CD ROM drive 100 (or other data reading and/or writing device such as a DVD drive or diskette drive) so that the chairperson—or other person to whom the base unit is allocated—can upload data from a CD ROM or other data storage device. The uploaded data, or a subset of the data, can then be transmitted to each of the satellite units for review by the other participants of a meeting. The data could comprise, for example, an agenda of issues to be discussed in the meeting. The CD ROM drive could be provided as an integral feature of the unit or alternatively it could be connected to the unit by means of an appropriate interface, such as a USB interface for example.

The base unit 30 additionally comprises a printing unit 90 which can be operated, as described above, to provide a hardcopy of data inputted by meeting participants and transmitted to the base unit 30. The printing unit 90 may also be operated to print any other data, such as for example the aforementioned agenda.

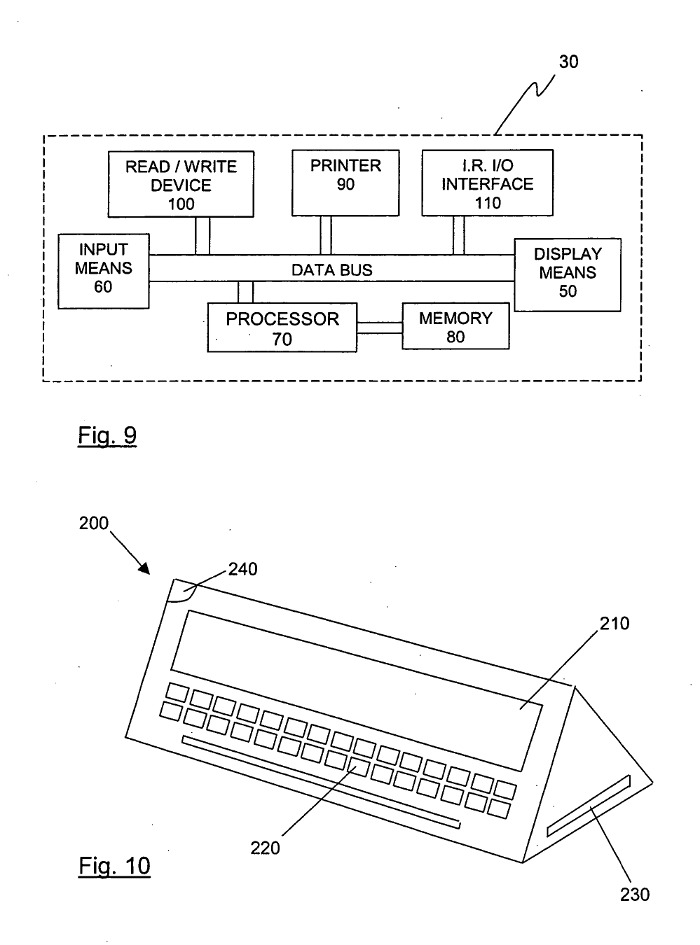

FIG. 9 is a schematic representation of the core components of the base unit shown in FIG. 7. As shown, the base unit 30 comprises (in addition to those components of the satellite unit mentioned above) an input/output interface to enable data to be transmitted to and/or received from one or more satellite units 10, or indeed transmitted to or received from another base unit 30. In the particular arrangement illustrated in FIG. 9, the input/output interface comprises an infrared port 110 and suitable components (not shown) to implement infrared wireless communications. In the preferred embodiment, the input/output interface 110 is also operable to receive data transmitted from other meeting aids or from other base units for processing by the processor 70. This is of particular advantage as it allows data held in the memory 80 of each of the meeting units 10 to be correlated in the memory of the base unit 30.

Another embodiment of the present invention is illustrated schematically in FIG. 10. The meeting aid of this embodiment is particularly well suited for meetings that have many participants (such as a large conference for example) where the participants are so widely dispersed that it is not really possible for each participant to easily see the meeting aid of each other participant. In such situations, it is more important for each participant to be provided with a list of the other participants, than for each participant to be able to visually identify the other participants by means of their meeting aids. To this end, this embodiment of the invention provides a meeting aid 200 which comprises a single display screen 210 provided on the wall of the aid that will be facing a given participant in use. The aid 200 may have a triangular cross-sectional shape (as shown) so that it does not have an unacceptably large footprint.

The aid 200 is provided with a keyboard 220 (or other equivalent input device) so that a participant to whom the aid has been assigned can input data into the unit. The aid 200 may also comprise a card reader 230 which is operable to read data from electronic business cards. The card reader may comprise, for example, a magnetic stripe reader, a chip-card reader or a bar-code reader. Further data entry/recording devices, such as a drive for recordable compact disks or a floppy disk drive, may also be provided. The aid is provided with, in this embodiment, a wireless communications interface 240 so that it can communicate with other similar aids assigned to other meeting participants. The card reader may also be configured to save data to an appropriate data storage medium.

In use, a given participant inputs data into the unit assigned to them, and this data is shared (by means of the communications port) with all other units so that each unit is provided with a list of all data for all participants that is saved in the memory of each unit. Any given participant may then scroll through the list (by using the keys or another appropriate control device), displaying items of data on the screen 210 of their unit, to ascertain—for example—who else is at the meeting. The list, as well as any other data, may be downloaded from the aid by means of the aforementioned data recording device, or by transmitting the list from the aid to an appropriate data storage device such as a hand-held PC or organiser.

Data sharing between units may be conducted in any of a number of different ways that will immediately be apparent to persons skilled in the art. For example, each aid could transmit inputted data to a master unit that is programmed to collate received data to generate the aforementioned list. To allow for the location of aids (and hence meeting participants) with respect to one another to be determined, the aids are set out in a predetermined configuration that is programmed into the master unit. Each communication from an aid to the master unit is prefaced by a code that uniquely identifies the aid sending the communication, and this allows the master unit to generate a list of participants which reflects the spatial orientation of the participants at the meeting. Once generated the list may then be broadcast from the master unit back to each aid. As an alternative example, each aid could broadcast data to all other aids and be programmed to compile the list from the data received from the other aids. In this case each aid may be provided with an indication of the spatial orientation of the other aids.

Whilst in this embodiment it is not intended for the aid to have a display screen other than that which is provided to display data to the person to whom the aid has been assigned, it will be appreciated that the aid could be provided with a further display screen (not shown) provided in the opposite face of the aid so that some information can be displayed to the other meeting participants.

It is also conceivable that whilst this embodiment of the invention is best employed by assigning each participant to an aid, a useful system could be employed where a number of aids are distributed throughout a convention or exhibition, for example, and any participant is able to go to an aid and scroll through the list of attendees to see who else is present at the convention.

It will also be appreciated that embodiments of the invention have been described above by way of example only, and that modifications may be made without departing from the spirit and scope of the invention as defined in the appended claims and elsewhere in this document. Although particular combination(s) of features have been explicitly enumerated in the following claims, it should be noted that the scope of the invention extends to any combination or permutation of features described herein irrespective of whether they have been described in the foregoing as forming part of any one embodiment or several different embodiments.

As an example of a potential modification, it has been noted that there is a growing trend for companies to provide employees with electronic business cards that are generally shaped as a business card, but which carry data on a data layer formed on (typically) one side of the card. To accommodate this trend the base unit and/or each of the satellite units may include an electronic business card reader (such as a device for reading data from a magnetic strip, a smart-card reader or a bar-code reader for example) which can communicate with the processor by means of the aforementioned data bus.

Alternatively or additionally, the base unit and/or satellite units may comprise an optical scanner (either as part or the unit or as a peripheral connectable to the unit) that is operable to generate an image of a standard business card, and the processor may be provided with optical character recognition software that is operable, when executed by the processor, to extract some or all of the printed information on the card from the image data.

In another arrangement, the data reading device may additionally be able to write data to a data storage device (such as a smart card, a card with a magnetic strip, or a recordable CD-ROM) inserted in the device. This arrangement would permit data inputted by other meeting participants (such as contact details for example) to be downloaded to the data storage device.

In another modification, the base unit and/or satellite units could be configured to be compatible with a telephone so that participants may take part in a meeting by telephone. A microphone and loudspeaker combination can be included on the device. Additionally a light may be included on the casing, and the light can be arranged to illuminate when the person assigned to the meeting aid is talking.

The base unit and/or the satellite units could also be modified to include a timer, and the timer may be pre-programmed to indicate when the meeting is supposed to end. The processor is responsive to the timer to sound an alarm or to flash a light to alert the participants when the time period allotted to the meeting is over. This arrangement is particularly advantageous as it allows careful time keeping to be observed.

Either or both of the satellite units and base unit may include a further display screen disposed on the top of the casing, adjacent to the input means. Such a screen aids the user in reviewing the information that they are entering, as well as giving a visual prompt of when messages and the like have been received.

The satellite units/base units may be battery powered or mains powered, and as described above they can be provided with a wireless or wired interface (they may even be provided with both). If battery powered, it is preferred that the batteries are rechargeable, and in a highly preferred arrangement the aids may be stacked—one on top of the other when in a recharging mode. This is advantageous in that each unit does not then need to be separately connected to a charger.

As an illustrative example, the side display panel display screens of the aid depicted in FIG. 6 may be in the region of 240 mm in length and 20 mm in height, and may be set roughly at 90 degrees to one another. A display screen provided for the participant to whom the aid has been allocated may be ¼ VGA (i.e. similar to that of a pocket pc screen) having a width of roughly 77 mm and a height of 58 mm, and is provided in the top face of the aid.

The side panel screens in this particular example are angled on the side of the device, and the aid is provided with a loudspeaker, and a number of dedicated navigation keys (such as cursors keys for example) which allow the user to navigate through menus and/or data. In this example, the aid has an infrared port (for wireless telecomms) and a USB port—for example, on the side that faces the participant to whom the aid has been allocated. The aid can have a mains connection point and in the preferred arrangement is shaped so that a number of aids can be stacked one on top of the other.

1. A meeting aid configured to facilitate the identification of persons in attendance at a meeting, said meeting aid being one of a set of such meeting aids each for allocation to a said person in attendance at a meeting, the meeting aid comprising:
a data input device configured to allow the person to whom the meeting aid has been allocated to input information identifying themselves;
communication means for receiving identifying information from one or more of the other meeting aids of said set of meeting aids;
a processing means configured to process and save received identifying information and identifying information inputted by the person to whom the meeting aid has been allocated, said saved identifying information providing the person to whom the meeting aid has been allocated with a list comprising at least a portion of the identifying information associated with those persons to whom each meeting aid of the set of meeting aids has been allocated; and
display means responsive to said processing means to display at least a portion of the inputted and received identifying information.

2. A meeting aid according to claim 1, wherein the display means is operable to display only to the person to whom that meeting aid has been allocated at least a portion of the inputted and received identifying information.

3. A meeting aid according to claim 2, comprising means operable to enable the person to whom the meeting aid has been allocated to scroll through the stored list of inputted and received identifying information.

4. A meeting aid according to claim 1, wherein the display means is responsive to said processing means to display at least a portion of the identifying information associated with the person to whom that aid has been allocated.

5. A meeting aid according to claim 4, wherein each meeting aid of the set of meeting aids is operable to display, to the other persons in attendance at the meeting, at least a portion of the identifying information associated with the person to whom that meeting aid has been allocated so that each person in attendance at the meeting can readily identify each of the other persons in attendance at the meeting.

6. A meeting aid according to claim 5, wherein said identifying information comprises the name of said person.

7. A meeting aid according to claim 6, wherein said display means is operable to display at least the name of said person.

8. A meeting aid according to claim 4, wherein said display means comprises a plurality of discrete display devices.

9. A meeting aid according to claim 8, comprising a top, bottom, and a plurality of sidewalls, a said display device being provided in each sidewall.

10. A meeting aid according to claim 8, wherein each said display device is configured to display the same information.

11. A meeting aid according to claim 1, wherein said data input device comprises a keyboard.

12. A meeting aid according to claim 1, wherein each said display device comprises a liquid crystal or light emitting diode display.

13. A meeting aid according to claim 1, comprising an electronic card reader integral to the aid or connected thereto by means of a suitable interface.

14. A meeting aid according to claim 1, comprising a data storage device integral to the aid or connected thereto by means of an interface.

15. A meeting aid according to claim 1, wherein said communication means is additionally operable to transmit identifying information to said one or more other meeting aids.

16. A meeting aid according to claim 1, wherein said communication means is operable to establish a wireless communications link between said meeting aid and said one or more other meeting aids.

17. A meeting aid according to claim 16, wherein said wireless link comprises an infrared or radio link.

18. A meeting aid according to claim 1, comprising timing means, particularly arranged to specify when meeting deadlines are due to expire.

19. A meeting aid according to claim 1, comprising means to allow the meeting aid to be associated with a telephone.

20. A meeting aid according to claim 19, comprising a microphone and a loudspeaker.

21. A meeting aid according to claim 19, comprising a light configured to illuminate when a phone user is speaking.

22. A system for facilitating the identification of persons in attendance at a meeting, the system comprising: a plurality of meeting aids according to claim 5, each meeting aid being assigned to a person in attendance at said meeting and being operable to display at least a part of the identifying information for the person to whom it is assigned.

23. A system for facilitating the identification of persons in attendance at a meeting, the system comprising: a plurality of meeting aids according to claim 3, each meeting aid being assigned to a person in attendance at said meeting and being operable to display at least part of the inputand/or received identifying information.

24. A system according to claim 22, wherein each meeting aid is shaped to permit each person at said meeting to see a display means of each meeting aid assigned to other persons present at said meeting to thereby permit a said person to view displayed identifying information for each other person attending said meeting.

25. A system according to claim 23, wherein the processing means of each meeting aid is operable to collate said identifying information to provide an indication of the position of each meeting aid, and hence each said person in attendance at the meeting, relative to the other meeting aids.

26. A system for facilitating the identification of persons in attendance at a meeting, the system comprising: a plurality of meeting aids according to claim 5, one of said meeting aids being configured as a base unit and the remainder being configured as satellite units, each meeting aid being assigned to a person in attendance at said meeting and being operable to display at least a part of the identifying information for the person to whom it is assigned.

27. A system according to claim 26, wherein said base unit comprises printer means.

28. A meeting aid device for facilitating identification of persons in attendance at a meeting, said device comprising:
a data input device to permit a user to input identifying information;
a transmitter for transmitting said identifying information to another said meeting aid device;
a receiver for receiving identifying information from respective transmitters of other said meeting aid devices;
a processor configured to process and save input and received identifying information and to create a list comprising at least a portion of the received identifying information; and
a display arrangement that displays at least a portion of the input and received identifying information.

29. A device according to claim 28, wherein said display arrangement comprises a display that faces in a first direction for viewing by a user of the device and at least one further display facing in a direction different to said first direction.

30. A device according to claim 28, wherein said transmitter can transmit said list to a device other than a said meeting aid.

31. A device according to claim 30, wherein said other device is a storage device and said meeting aid device has an output by which it is connectable to said storage device.

32. A device according to claim 28, having an output that permits said list to be communicated to a printer.

33. A device according to claim 28, wherein said display arrangement permits said input identifying data to be visible throughout 360°.

34. A meeting aid system comprising a plurality of meeting aid devices for facilitating identification of persons in attendance at a meeting, each said device comprising:
a data entry device for inputting identifying data that identifies a user of the meeting aid device;
a transmitter for transmitting said identifying data to the other said meeting aid devices;
a receiver for receiving identifying information transmitted from the other said meeting devices;
a computing module for processing the received identifying data;
a first display facing in a first direction on which the received identifying information can be displayed for viewing by a user of the meeting aid device; and at least one further display facing in a direction different to said first direction for displaying the input identifying information for viewing by persons other than the user of the meeting aid device.

35. A system according to claim 34, in which each said meeting aid device has two said further displays provided on respective sides of the meeting aid device.

36. A meeting aid system for identifying attendees at a meeting, said meeting aid system comprising a plurality of satellite meeting aid devices and a base unit, each satellite meeting aid device comprising:
a data entry device for inputting information identifying an attendee assigned the meeting aid;
a communications link to said base unit for communicating said identifying information to said base unit; and
a display for displaying at least a portion of said identifying information; and
said base unit comprising a processor for processing identifying information communicated from the satellite meeting aid devices to provide a record of attendees at a meeting.

37. A system according to claim 36, wherein said base unit comprises:
a data entry device for inputting identifying data identifying an attendee assigned the base unit; and
a display for displaying at least a portion of said identifying data input by the attendee assigned the base unit.

38. A system according to claim 36, wherein said base unit comprises a printer.

39. A system as claimed in claim 36, wherein said base unit comprises an interface to enable data from said processor to be saved to an external memory device.

40. A system as claimed in claim 36, wherein said satellite meeting aid devices each comprise a receiver for receiving data from said base unit.

41. A system as claimed in claim 36, wherein said satellite meeting aid devices each comprise a receiver for receiving data from said communications link.
